(19) United States
(12) Patent Application Publication
(10) Pub. No.: US 2026/0213951 A1
(43) Pub. Date: Jul. 23, 2026

(54) METHOD OF MULTI-DESERIALIZING FOR HASH COMPUTATION AND CHIP ADOPTING THE SAME

(71) Applicant: Soteria Inc., Seoul (KR)

(72) Inventors: Gihong PARK, Hwaseong-si (KR); Sinho Yang, Hwaseong-si (KR); James Jongman Kim, Seongnam-si (KR)

(73) Assignee: Soteria Inc., Seoul (KR)

(21) Appl. No.: 19/384,016

(22) Filed: Nov. 10, 2025

(30) Foreign Application Priority Data
Nov. 15, 2024 (KR) 10-2024-0163249

(51) Int. Cl. H04L 9/32

(52) U.S. Cl. CPC H04L 9/3239

(57) ABSTRACT

The present disclosure relates to a method of multi-deserializing for hash computation and a hash computing chip adopting the same, when repeatedly and concurrently performing hash computations with clusters including a plurality of SHA-256 hash computation stages, to significantly alleviating routing complexity by narrowing data bus width required to transfer hash intermediate states, through provisioning of serialized data achieved by serializing 8 32-bit hash intermediate states to each of the plurality of clusters, and deserializing of the serialized data to restore the 8 32-bit hash intermediate states restored and to be used in each cluster.

### CROSS REFERENCE TO RELATED APPLICATION

This application claims priority to Korea Patent Application No. 10-202024-0163249 filed on Nov. 15, 2024, the content of which is expressly incorporated by reference in its entirety.

### TECHNICAL FIELD

The present disclosure relates to a method of multi-deserializing for hash computation and a hash computing chip adopting the same, more particularly, when repeatedly and concurrently performing hash computations with clusters including a plurality of SHA-256 hash computation stages, to significantly alleviating routing complexity by narrowing data bus width required to transfer hash intermediate states, through provisioning of serialized data achieved by serializing 8 32-bit hash intermediate states to each of the plurality of clusters, and deserializing of the serialized data to restore the 8 32-bit hash intermediate states restored and to be used in each cluster.

### BACKGROUND

When designing a semiconductor chip, key issues that should be taken into consideration include performance, power consumption, chip area, and heat dissipation. In order to satisfy these design issues, it is necessary to simplify the routing of data buses as much as possible during the chip design process.

In a semiconductor circuit, since signals are moved through wires, as the length and complexity of the wires increase, not only does the physical area occupied by the wires increase, but the capacitive load that circuit components should drive also becomes larger. As a result, signal propagation delays increase, leading to a degradation in overall circuit performance.

Accordingly, reducing the bit-width or the length of the interconnected wires used for data transmission shortens the signal propagation time and enables operations at relatively higher clock frequencies, thereby allowing more operations to be performed per a unit time.

Furthermore, the complexity of wiring significantly affects power consumption. Wider and longer wiring interconnects consume more power, and excessive power consumption can lead to heat generation issue. This, in turn, may cause interference with other circuits and result in malfunction. Therefore, it is necessary to optimize the routing of wiring interconnects to mitigate such issues.

In addition, the complexity of wiring interconnects in a semiconductor chip may affect a significant impact on deciding overall chip area. Reducing the area occupied by wiring interconnects may contribute to lowering production costs and improving yield during mass production.

Furthermore, a design that reduces routing complexity in a semiconductor chip plays a critical role in minimizing defects that may occur during the manufacturing process. For example, when a large number of wires are densely placed within a narrow space and operated at high speeds, the probability of defects arising during fabrication (or manufacturing) process increases. Accordingly, reducing routing complexity facilitates easier testing and debugging of the circuit, and thus it enables rapid identification and resolution of potential issues occurring after manufacturing process.

In the case of a semiconductor chip designed for Bitcoin mining, it is necessary to repeatedly perform multiple SHA-256 (Secure Hash Algorithm 256) hash computations. Therefore, such a chip should be developed as ultra-high-speed, low-power, and high-density semiconductor device suitable for executing large volumes of complex hash computations efficiently.

Accordingly, the present disclosure proposes a hash computing chip configured to repeatedly and concurrently perform hash computations by including a plurality of clusters, each comprising multiple stages for executing multiple SHA-256 hash computations.

In this configuration, 8 32-bit hash intermediate states are serialized and the serialized data is provided to each of the plurality of clusters. The serial data is then deserialized by each cluster for use. By significantly reducing the data bus bit width from 256 bits to 1 bit, the chip area is reduced, the performance of the chip is improved, and the power consumption of the chip is reduced.

Hereinafter, a prior art existing in the technical field of the present disclosure is briefly explained, and the technical features that the present disclosure aims to achieve in a differentiated manner compared to the aforementioned prior art are described.

Korean Patent Publication No. 2023-0062649 A (May 9, 2023) relates to a computing system for digital currency, comprising a plurality of computing devices and a signal transmission path connecting the plurality of computing devices in series. Each computing device is connected to the signal transmission path via a first port and a second port, and a first computing device and a second computing device each receive signals specified by the chip address from the signal transmission path via one of the first port and the second port to a local storage device, while signals not specified by the chip address are configured not to be received.

The prior art discloses that each chip on a computing board transmits and receives data via communication protocols such as I2C (Inter-Integrated Circuit), SPI (Serial Peripheral Interface), or UART (Universal Asynchronous Receiver Transmitter). However, when performing hash computations using a plurality of clusters each comprising two SHA-256 stages as proposed in the present disclosure, the structure of serializing 8 32-bit hash intermediate states into serialized data to reduce the data bus width, and subsequently receiving and deserializing the serialized data at each cluster to restore the 8 32-bit hash intermediate states for use in each round-thereby significantly alleviating routing complexity-is neither disclosed nor suggested explicitly or implicitly in the prior art.

### BRIEF SUMMARY OF THE EMBODIMENTS

In order to solve the above-mentioned problems, it is an objective of the the present disclosure to provide a hash computing chip comprising multiple clusters, each including multiple stages performing multiple SHA-256 hash computations, so that the hash computations can be repeatedly and concurrently executed.

It is another objective of the present disclosure to improve issues such as increased power consumption, increased hardware area, and delayed data processing speed of the hash computing chip, caused by routing complexity.

It is another objective of the present disclosure to reduce the routing complexity caused by a 256-bit data width to a 1-bit data width, when the 256-bit hash intermediate states output from the SHA-256 hash computation of a previous stage are inputted to the SHA-256 hash computation of a subsequent stage in each cluster of the hash computing chip.

It is another objective of the present disclosure to provide a method of serializing 8 32-bit hash intermediate states, which are the results of the SHA-256 hash computation of a previous stage, and providing the results to the SHA-256 hash computation of a subsequent stage, and then deserializing the serialized results in the SHA-256 hash computation of the subsequent stage to input the deserialized data into each round.

It is characterized in that a method of hash computation through multi-deserializing comprise: by a first deserializer, first deserializing serialized data into 8 32-bit hash intermediate states to restore the result of a previous SHA-256 hash computation, wherein the serialized data is converted from 8 32-bit hash intermediate states output from the previous SHA-256 hash computation; and by a subsequent SHA-256 hash computation circuit, performing a subsequent SHA-256 hash computation by inputting the 8 32-bit hash intermediate states restored by the first deserializing to rounds of the subsequent SHA-256 hash computation, wherein the serialized data is multi-deserialized and the multi-deserialized data are used for inputs of the rounds for a plurality of SHA-256 hash computations, and thereby alleviating routing complexity by reducing bit width of data required to transmit the hash intermediate states.

It is characterized in that the method further comprises: by a second deserializer, second deserializing the serialized data into the 8 32-bit hash intermediate states to restore the result of the previous SHA-256 hash computation, wherein the serialized data is converted from the 8 32-bit hash intermediate states output from the previous SHA-256 hash computation; and by a first adder, adding the result of the subsequent SHA-256 hash computation to the restored result of the previous SHA-256 hash computation.

It is characterized in that the hash intermediate states are one of a computation result obtained by 64th round of 0th SHA-256 hash computation, or a computation result obtained by pre-computations of 0th to 3rd round of 1st SHA-256 hash computation in addition to the 64th round of the 0th SHA-256 hash computation, in a structure consecutively performing a plurality of SHA-256 hash computations.

It is characterized in that the performing of the subsequent SHA-256 hash computation includes: performing one of the computations of 64 rounds of the 1st SHA-256 hash computation, or the computations from 5th round to 64th round of the 1st SHA-256 hash computation, in the structure consecutively performing the plurality of SHA-256 hash computations.

It is characterized in that the method further comprises sharing a serial bus for transmitting the serialized data to consecutively perform the plurality of SHA-256 hash computations, by unrolling over a plurality of different versions and rolling for 32-bit nonce.

Meanwhile, it is characterized in that a hash computing chip according to another embodiment of the present disclosure comprises: a cluster_top; and a plurality of clusters, wherein the cluster_top is configured to convert hash intermediate states of a SHA-256 hash computation into serialized data and provide the serialized data to the plurality of clusters, the plurality of clusters are configured to deserialize the serialized data received from the cluster_top and perform remaining SHA-256 hash computations subsequently to the SHA-256 hash computation of the cluster_top, and the serialized data is multi-deserialized and the multi-deserialized data are used for inputs of the rounds for a plurality of SHA-256 hash computations, and thereby alleviating routing complexity by reducing bit width of data required to transmit the hash intermediate states

It is characterized in that each of the plurality of clusters include: a first stage and a second stage, the first stage includes a predetermined number of first deserializers; a predetermined number of hash computation circuits; a predetermined number of second deserializers; and a predetermined number of adders, and the second stage is configured to receive each of the computation results of the first stage as an input message, perform message expansion for the input message, perform computations for a plurality of round functions, and output a predetermined number of hash computation results each by adding an initial vector to corresponding final result of the plurality of round functions.

It is characterized in that the hash computing chip is further configured to share a serial bus for transmitting the serialized data to consecutively perform the plurality of SHA-256 hash computations, by unrolling over a plurality of different versions and rolling for 32-bit nonce.

It is characterized in that each of the plurality of clusters comprises: a first deserializer configured to receive serialized data converted from 8 32-bit hash intermediate states output from a previous SHA-256 hash computation circuit, and deserialize the received serialized data back into the 8 32-bit hash intermediate states to restore the result of the previous SHA-256 hash computation; and a subsequent SHA-256 hash computation circuit configured to input the 8 32-bit hash intermediate states restored by the first deserializer to round circuits of the subsequent SHA-256 hash computation circuit and perform the subsequent SHA-256 hash computation.

It is characterized in that each of the plurality of clusters comprises: a second deserializer configured to receive serialized data converted from 8 32-bit hash intermediate states output from a previous SHA-256 hash computation circuit, and deserialize the received serialized data back into the 8 32-bit hash intermediate states to restore the result of the previous SHA-256 hash computation; and a first adder configured to add the result of the subsequent SHA-256 hash computation to the restored result of the previous SHA-256 hash computation.

It is characterized in that the hash intermediate states are one of a computation result obtained by 64th round circuit of 0th SHA-256 hash computation circuit, or a computation result obtained by pre-computations of 0th to 3rd round circuit of 1st SHA-256 hash computation circuit in addition to the 64th round of the 0th SHA-256 hash computation circuit, in a structure consecutively performing a plurality of SHA-256 hash computations.

It is characterized in that the subsequent SHA-256 hash computation circuit includes: one of computation circuits configured to perform 64 rounds of the 1st SHA-256 hash computation, or computation circuits configured to perform 5th round to 64th round of the 1st SHA-256 hash computation, in the structure consecutively performing the plurality of SHA-256 hash computations.

As described above, the hash computing chip according to the present disclosure is configured to perform hash computations repeatedly with a plurality of clusters including a plurality of stages configured to perform a plurality of SHA-256 hash computations, thereby it is effective to increase the hash rate by improving chip performance.

In addition, the hash computing chip according to the present disclosure is configured to serialize 8 32-bit hash intermediate states, which are the result of a previous SHA-256 hash computation circuit, transmit the serialized data to a subsequent SHA-256 hash computation circuit, and then deserialize the serialized data for use in each round of the subsequent SHA-256 hash computation circuits, thereby it is effective to reduce hardware area and power consumption and improve performance by alleviating routing complexity.

Furthermore, the hash computing chip according to the present disclosure is configured to alleviate the routing complexity caused by the 256-bit data width to 1-bit data width, when inputting the hash intermediate states output from the previous SHA-256 hash computation circuit to the subsequent SHA-256 hash computation circuit in each cluster, thereby it is effective to reduce hardware area and power consumption, improve the performance, reliability and yield of the hash computing chip.

### BRIEF DESCRIPTION OF THE DRAWINGS

FIG. 1 is a block diagram of a hash computation circuit for Bitcoin mining to which the multi-deserializing method for hash computation is applied according to an embodiment of the present disclosure.

FIG. 2 is a block diagram of a single SHA-256 hash computation circuit to which the multi-deserializing method for hash computation is applied according to an embodiment of the present disclosure.

FIG. 3 is a diagram illustrating the configuration performing multiple SHA-256 hash computations by transmitting hash intermediate states as serialized data between clusters adopting the multi-deserializing method for hash computation according to an embodiment of the present disclosure.

FIG. 4 is a block diagram illustrating the configuration of a cluster_top adopting the multi-deserializing method for hash computation according to an embodiment of the present disclosure.

FIG. 5 is a diagram illustrating the configuration of a hash computing chip adopting the multi-deserializing method for hash computation according to an embodiment of the present disclosure.

FIG. 6A is a diagram illustrating the concept of multi-deserializing for the case that entire multiple rounds are provided in a stage of a cluster adopting the multi-deserializing method for hash computation according to embodiments of the present disclosure.

FIG. 6B is a diagram illustrating the concept of multi-deserializing for the case that a part of multiple rounds are provided in a stage of a cluster adopting the multi-deserializing method for hash computation according to embodiments of the present disclosure.

FIG. 7 is a structure illustrating a hash computing chip adopting the multi-deserializing method for hash computation according to an embodiment of the present disclosure.

FIG. 8 is a flowchart showing a hash computing process adopting the multi-deserializing method for hash computation according to an embodiment of the present disclosure.

The reference numerals are described as follows: a hash computing chip as 10, an expander as 100, a compressor as 200, a cluster_top as 1000, a serializer as 1100, a cluster as 2000, a first stage as 2100, a second stage as 2200, a first deserializer as 2110, a second deserializer as 2120, a hash computation circuit as 2130, and an adder as 2140.

### DETAILED DESCRIPTION OF EXAMPLE EMBODIMENTS

Hereinafter, example embodiments of a multi-deserializing method for hash computation and a hash computing chip adopting the same according to the present disclosure will be described in detail with reference to the accompanying drawings. Identical reference numerals used in the drawings denote the same elements throughout. In addition, specific structural or functional descriptions of the embodiments of the present disclosure are merely illustrative for the purpose of describing the embodiments and are not intended to limit the scope of the disclosure. Unless otherwise defined, all terms used herein, including technical and scientific terms, are to be interpreted as having the meanings that are commonly understood by ordinary skilled persons in the art to which this disclosure pertains. Terms that are commonly defined in general dictionaries should be interpreted as having meanings consistent with the context of the relevant technical field and should not be interpreted in an overly idealized or excessively formal sense unless expressly defined otherwise in the present specification.

The hash computation according to an embodiment of the present disclosure is used for Bitcoin mining and employs a three-stage SHA-256 (Secure Hash Algorithm 256) hash computations (i.e., double SHA-256). For Bitcoin mining, it is necessary to repeatedly perform SHA-256 hash computations on 2³² different nonces for each of 2³² versions of the input message in order to find valid hash values.

Accordingly, a hash computing chip for Bitcoin mining should perform three-stage SHA-256 hash computations by rolling 2³² nonces for each of multiple versions, and the architecture of the hash computing chip can be configured more efficiently by leveraging the features of the three-stage SHA-256 hash computations.

Specifically, in the three-stage SHA-256 hash computations, only the version and nonce fields of the input message vary across 2³² combinations. Therefore, it is possible to firstly consider a structure that processes all 2³² (=4,294,967,296) nonces for a single version.

In the three-stage SHA-256 hash computations, the nonce is processed during the second and third stages of the SHA-256 computations. That is, while performing hash computations for 2³² different nonces, the first SHA-256 hash computation needs to be executed only once for a single version. Furthermore, in the first SHA-256 stage, only the version field changes across 2³² times, while the rest of the input message remains unchanged.

Accordingly, in the hash computing chip according to the present disclosure, the first SHA-256 hash computation is pre-computed by a cluster_top. The resulting hash intermediate states are then transmitted to a plurality of clusters, each of which performs the second and third SHA-256 hash computations. These clusters are configured to perform distributed processing of 2³² nonces through iterative execution.

In designing hardware to perform such three-stage SHA-256 hash computations, the hash intermediate states generated by the cluster_top through the first SHA-256 hash computation should be distributed to multiple clusters in order to concurrently perform hash computations for 2³² nonces. To transmit the hash intermediate states to the plurality of clusters, a data bus with a total width of 256 bits corresponding to 8 32-bit hash intermediate states should be used.

In designing a semiconductor chip, the computations processed in the above three-stage SHA-256 hash computations can be divided into common computations and individually repetitive computations. The semiconductor chip can be configured such that the common computations for multiple versions are handled by a cluster_top and the individually repetitive computations for 2³² nonces are distributed across a plurality of clusters for concurrent parallel processing.

By configuring the chip in this manner, even if one of the clusters fails, the remaining clusters can take over the workload of the failed cluster, thereby preventing the entire chip from ceasing the hash computations due to the failure of a specific cluster. The workload of the failed cluster can be seamlessly excluded, and other clusters can automatically take over the workload, thereby enabling a highly reliable chip to be designed.

For example, when designing a chip that processes 2³² nonces for multiple versions, if the chip includes approximately 250 clusters, each cluster can be assigned to perform hash computations for approximately 17 million nonces. This results in a total of approximately 4.25 billion hash computations. Since the number of hash computations is slightly less than 2³², the number of clusters or the number of iterations can be slightly adjusted as needed.

As illustrated in the above example, when approximately 250 clusters are configured and the hash intermediate states should be delivered to each of the clusters, connecting the clusters via a data bus with 256-bit width results in significant routing complexity, which, in turn, substantially increases the chip size, thereby leading to inefficiencies.

Furthermore, if semiconductor technology is to be employed that allows a single chip to process four versions concurrently, the aforementioned routing complexity may prevent a single chip from handling four versions simultaneously due to limitations in area and interconnect resources.

Accordingly, the present disclosure proposes a structure in which when a plurality of clusters, each comprising two SHA-256 hash computation stages (a first stage and a second stage), perform distributed and repeated hash computations, the 8 32-bit hash intermediate states are delivered as serialized data instead of providing the 8 32-bit hash intermediate states to each cluster in parallel in order to reduce the bit width of the data bus.

In this configuration, each of the plurality of clusters receives the serialized data of the hash intermediate states and applies a multi-deserializing process to reconstruct back the hash intermediate states for use in the round circuits, thereby significantly reducing routing complexity.

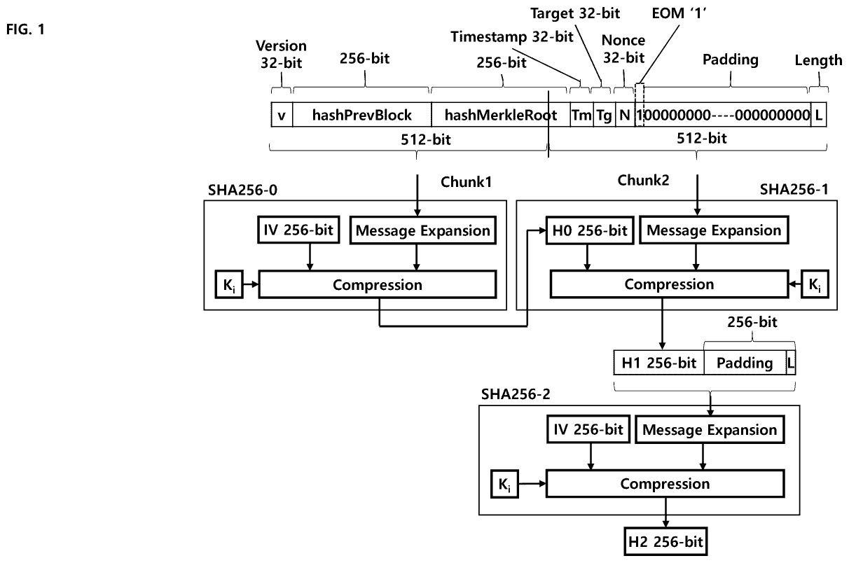

FIG. 1 is a block diagram of a hash computation circuit for Bitcoin mining to which the multi-deserializing method for hash computation is applied according to an embodiment of the present disclosure.

As shown in FIG. 1, the process of performing hash computation for Bitcoin mining begins by receiving an input message and dividing the input message into 512-bit units. If the total length of the input message exceeds 512 bits, the excess portion is used to construct another 512-bit input message. If the input message is shorter than 512 bits, zeros are padded to complete the 512-bit unit.

Specifically, in the case of Bitcoin, the actual message content of the input message includes a 32-bit version, a 256-bit hash block derived from the previous hash computation (hashPrevBlock), a 256-bit Merkle root (hashMerkleRoot), a 32-bit timestamp, a 32-bit target value, and a 32-bit nonce. To use this actual message content for a hash computation, a bit of ‘1’ indicating the end of the message is appended at the end of the message content. Additionally, in the last 32 bits of the 512-bit input message, the message length (e.g., 0x00000280=640 bits) is added. Zero (‘0’) bits are padded between the appended bit ‘1’ indicating the end of the message (EOM) and the message length.

As illustrated in the above example, once two 512-bit input messages are prepared, the first 512-bit input message undergoes message expansion in the first SHA-256 stage (SHA 256-0), in which 16 32-bit input words are expanded and scheduled into 64 32-bit words.

Subsequently, the expanded input message, along with the input constants (K) and a 256-bit initialization vector (IV), is processed through compression, resulting in the output of a 256-bit hash digest (H0).

The 256-bit hash digest (H0) thus generated is then input to the second SHA-256 stage (SHA256-1). The hash digest H0 and input constant K, together with the input message expanded and scheduled the second 512-bit (16×32-bit words) into 64 32-bit words, are input into the compression.

The result of the compression is a 256-bit hash value (hash digest) (H1), which forms the input message for the third SHA-256 stage (SHA256-2). Since the hash value H1 itself becomes the input message, a ‘1’ bit is appended, and a 64-bit message length field is added at the end of the input message. In this case, the message length is 0x00000100 (=256).

The third hash computation, SHA256-2, takes the 256-bit initialization vector (IV), input constant (K), and 64 32-bit words message expanded and scheduled from the input message are input to the compression, and then resulting in a final hash value.

If the value adding the resulting final hash value to the initialization vector(IV) is less than or equal to the target value, it indicates that a new block has been successfully found.

Wherein, each of the hash computations (SHA256-0, SHA256-1, and SHA256-2) requires message expansions which may be implemented by a pipeline circuit comprising 48 pipeline stages each processing 16 32-bit data words and pipeline stages constructed by progressively reducing one of the 16 32-bit register groups at each stage from the 48th to the 64th stages. That is, the pipeline stages are formed by removing the register group corresponding to the longest propagated 32-bit data word.

According to the SHA-256 hash algorithm, the initial 16 32-bit words of the 512-bit message are directly input to the first 16 round functions of the compression. Thereafter, the 16 32-bit message words are expanded to 48 additional 32-bit words according to [Equation 1] computing Wᵢ, and the expanded messages are input to the subsequent 48 round functions of the compression.

$${W}_{i} = {M}_{i} , 0 \leq i \leq 15 , \qquad [ Equation 1 ]$$

$${W}_{i} = {σ}_{1} ( {W}_{i - 2} ) + {W}_{i - 7} + {σ}_{0} ( {W}_{i - 15} ) + {W}_{i - 16} , 16 \leq i \leq 63.$$

Here, σ₀(x) is defined as ROTR7(x) XOR ROTR18(x) XOR SHR3(x), and
σ₁(x) is defined as ROTR17(x) XOR ROTR19(x) XOR SHR10(x), ROTR7 is a right rotation by 7 bits, in which the higher-order bits are shifted toward the lower-order bits one by one, and the least significant bit (LSB) is wrapped around to fill the most significant bit (MSB), SHR3 denotes an computation that shifts the bits of x to the right by 3 positions, filling the leftmost bits with zeros. Moreover, the XOR computation represents a bitwise exclusive OR.

Moreover, the compression performed by the compressor is expressed by [Equation 2], which represents the round functions executed over 64 rounds, from 0th to 63th.

$${h}_{i + 1} = {g}_{i} ; {g}_{i + 1} = {f}_{i} ; {f}_{i + 1} = {e}_{i} ; \qquad [ Equation 2 ]$$

$${e}_{i + 1} = {d}_{i} + {h}_{i} + {\sum }_{1} ( {e}_{i} ) + Ch ( {e}_{i} , {f}_{i} , {g}_{i} ) + {K}_{i} + {W}_{i} ;$$

$${d}_{i + 1} = {c}_{i} ; {c}_{i + 1} = {b}_{i} ; {b}_{i + 1} = {a}_{i} ;$$

$${a}_{i + 1} = {h}_{i} + {\sum }_{1} ( {e}_{i} ) + Ch ( {e}_{i} , {f}_{i} , {g}_{i} ) + {\sum }_{0} ( {a}_{i} ) + Maj ( {a}_{i} , {b}_{i} , {c}_{i} ) + {K}_{i} + {W}_{i} .$$

Here, Ch(x, y, z)=(x AND y) XOR (NOT(x) AND z), Maj(x, y, z)=(x AND y) XOR (x AND z) XOR (y AND z), Σ₀(x)=ROTR2(x) XOR ROTR13(x) XOR ROTR22(x), Σ1(x)=ROTR6(x) XOR ROTR11(x) XOR ROTR25(x).

When performing hash computations for Bitcoin mining as described above, SHA-256 hash computation should be processed over three stages. Each SHA-256 hash computation requires a large-scale pipeline circuit for message expansion, as well as a large-scale pipeline circuit for compression that receives the expanded message and processes the 64 round functions.

According to the present disclosure, when a compressor is configured as a pipeline circuit in each hash computation, the complexity of the pipeline circuit is reduced based on the correlation between adjacent circuits in the process that an computation for a round function is performed in a specific pipeline stage and the results thereof are stored in register groups and transmitted to a subsequent pipeline stage, thereby improving the performance and reducing power consumption for the hash computation circuit including the compressor.

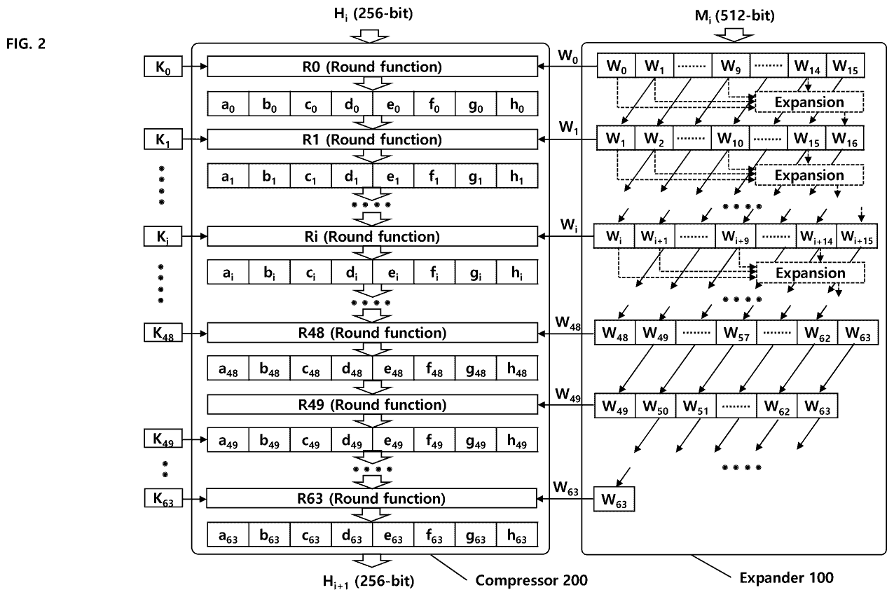

FIG. 2 is a block diagram of a single SHA-256 hash computation circuit to which the multi-deserializing method for hash computation is applied according to an embodiment of the present disclosure.

As shown in FIG. 2, the SHA-256 hash computation circuit used for hash computation according to an embodiment of the present disclosure includes an expander configured to sequentially provide input data comprising an input message and expanded data generated by expanding the input message, and a compressor configured to sequentially apply the input data and the expanded data to round function circuits for performing compression.

The expander 100 is implemented with a pipeline circuit in hardware based on [Equation 1], and the compressor 200 is implemented with a pipeline circuit in hardware based on [Equation 2].

In the SHA-256 hash computation, the expander 100 is configured to receive 512 bits of an input message composed of 16 32-bit words and output 16 32-bit input data words (W₀~W₁₅) and 48 32-bit expanded data words (W₁₆~W₆₃). The data words, W₀~W₆₃ are input to the round functions (R₀~R₆₃) of the compressor 200 to output 8 32-bit hash digest.

In such an SHA-256 hash computation, the configuration of the expander 100 is such that the expander receives 512 bits of input message (Mᵢ), composed of 16 32-bit words, stores the input message in 16 32-bit register groups, and sequentially provides W₀ through W₁₅ to the round functions of the compressor 200 from round 0 to round 15 to compute the round functions. Referring to [Equation 1], the register group for the round 16 is generated by an expansion computation according to W₁₆=σ₁(W₁₄)+W₉+σ₀(W₁)+W₀. This expansion process continues to W₆₃ is output. Since previous Wᵢ values should be stored in the register group for this computation, a large-scale pipeline circuit is required.

Each Wᵢ output from the expander 100 is input to the round function (Rᵢ) of the compressor 200, and as a result, hash intermediate states as variables (aᵢ, bᵢ, cᵢ, dᵢ, eᵢ, fᵢ, gᵢ, hᵢ) are output at each stage of rounds. The compression is computed over a total of 64 rounds.

As shown in FIG. 1, the hash computation for Bitcoin mining has a structure in which SHA256-0, SHA256-1, and SHA256-2 are sequentially computed. Accordingly, both the expansion computation by the expander 100 and the compression computation by the compressor 200 should be executed over three times, respectively.

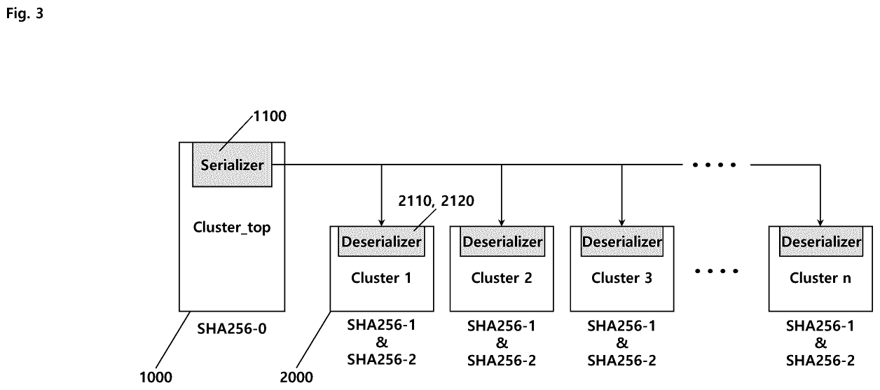

FIG. 3 is a diagram illustrating the configuration performing multiple SHA-256 hash computations by transmitting hash intermediate states as serialized data between clusters adopting the multi-deserializing method for hash computation according to an embodiment of the present disclosure.

As shown in FIG. 3, the multi-deserializing method for hash computation according to an embodiment of the present disclosure begins with pre-computing a first SHA-256 hash computation (SHA256-0) out of three-stage SHA-256 hash computations in advance at the cluster_top 1000 for a plurality of specific versions.

Next, the result of the SHA256-0 hash computation is converted into serialized data 1100 and the serialized data is transmitted to clusters 1, 2, ..., n, 2000 as hash intermediate states.

In this process, if the hash computation result of SHA256-0 is transmitted to each cluster 2000 as serialized data, each cluster should be configured to perform respective expansion and compression computations based on nonce. On the other hand, if the cluster_top 1000 performs not only the SHA256-0 hash computation but also the expansion and compression computations for the first four input messages including the nonce of SHA256-1, and then serializes the resulting hash intermediate states and transmits the serialized data to each cluster 2000, all each of the individual clusters 2000 can be configured to receive the hash intermediate states in serial and execute hash computations starting from the 5th round of the SHA256-1 hash computation to the SHA256-2 hash computation.

That is, the chip can be configured to the configuration such that the cluster_top performs SHA256-0 and each cluster performs SHA256-1 and SHA256-2, or alternatively, the cluster_top performs SHA256-0 and the first four rounds of SHA256-1 and each cluster performs hash computations starting from the 5th round of SHA256-1 to SHA256-2 hash computation.

Since such configurations of the cluster_top and clusters can be established for multiple versions, n clusters corresponding to the number of versions can be provided, and the cluster_top can output multiple hash intermediate states performing SHA256-0 while incrementing only one version at a time for multiple versions and provide each of the hash intermediate states to the corresponding cluster.

At this time, the cluster_top 1000 can serialize the hash intermediate states for each version and provide the hash intermediate states to the clusters 2000 configured to handle 2³² nonces for corresponding version. Furthermore, by serializing, at the serializer 1100, hash intermediate states for each of multiple versions, multiplexing the serialized hash intermediate states, and providing the multiplexed serialized hash intermediate states to all clusters, each cluster 2000 can select the required hash intermediate states and use the selected hash intermediate states through demultiplexing and deserialization 2110.

Even the serialized data generated by the cluster_top according to the present disclosure is deserialized and used at each cluster, the time required for performing the hash computation for a single version at the cluster_top, serializing the hash intermediate states at the cluster_top, and subsequently deserializing the serialized hash intermediate states at each cluster, corresponds to an extremely short time compared to the time taken to repeatedly perform the hash computation distributed across 2³² nonces at each cluster.

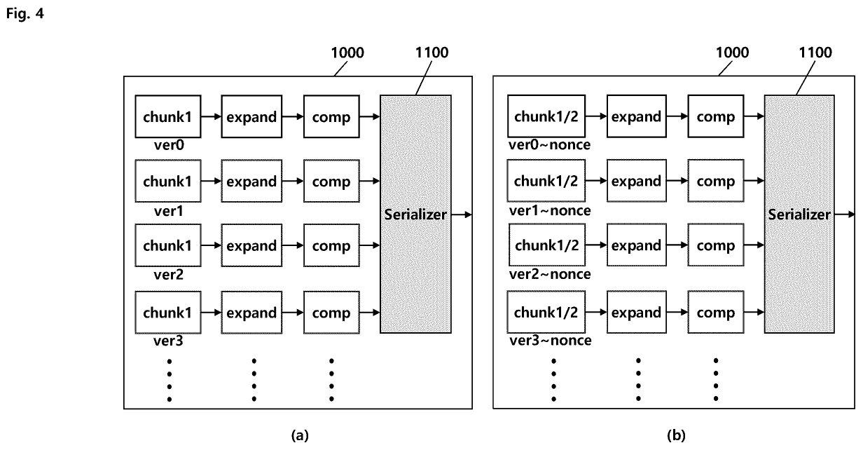

FIG. 4 is a block diagram illustrating the configuration of a cluster_top adopting the multi-deserializing method for hash computation according to an embodiment of the present disclosure.

As shown in FIG. 4, the cluster_top for hash computations according to an embodiment of the present disclosure is arranged such that (a) SHA256-0 hash computations for the chunk 1 input messages for multiple different versions are concurrently performed by expansions and compressions and the hash intermediate states for each of the multiple different versions are multiplexed and serialized by a serializer 1100 for output, or (b) in addition to concurrently perform SHA256-0 hash computations for the chunk 1 input messages by respectively performing expansions and compressions for multiple different versions, SHA256-1 hash computations up to four input messages including the nonce of the chunk 2 are concurrently performed by expansions and compressions for multiple different versions and the fourth hash intermediate states of SHA256-1 for the multiple different versions are multiplexed and serialized by a serializer 1100 for output.

In this case, the serialization is performed individually for each version and provided separately to the corresponding cluster, or the results serialized for each of the multiple versions are multiplexed and provided to the corresponding clusters.

If serialized data generated for each of the multiple versions is transmitted separately, the control over the transmission of the serialized data is simple. However, the buses for transmitting the serialized data are required as many as the number of versions. If multiple serialized data generated for the multiple versions are multiplexed and transmitted, only a single serialized data bus line is needed, but the multiple serialized data should be transmitted and received so as to be separated and synchronized with execution timing for each version.

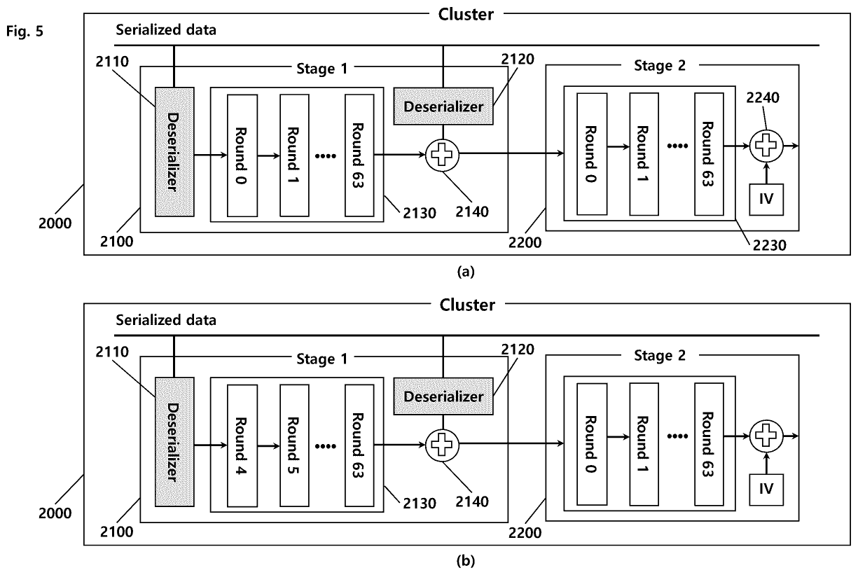

FIG. 5 is a diagram illustrating the configuration of a hash computing chip adopting the multi-deserializing method for hash computation according to an embodiment of the present disclosure.

As shown in FIG. 5, the multi-deserializing method for hash computation according to an embodiment of the present disclosure comprises deserializing serialized data received through a first deserializer 2110 of each cluster 2000 into 8 32-bit hash intermediate states, and inputting the deserialized hash intermediate states to a hash computing circuit 2130 for computing rounds (including expansions and compressions), wherein the serialized data is converted from 8 32-bit hash intermediate states obtained by performing the SHA256-0 hash computation at a serializer 1100 of the cluster_top 1000 and transmitted to each of the multiple clusters. In addition, the multi-deserializing method further comprises deserializing the serialized data (the result of of the SHA256-0 hash computation) transmitted from the cluster_top 1000 to a second deserializer 2120, and adding, by the adder 2140, the deserialized result to the result of 64 rounds performed by the hash computation circuit 2130, and then outputting the added result from the first stage 2100 to the second stage 2200.

If the cluster_top 1000 converts the hash intermediate states obtained by performing up to the first four rounds of SHA256-1 in addition to SHA256-0 to serialized data at the serialiser 1100 and transmits the serialized data to each of the clusters, the first deserializer 2110 deserializes the serialized data, and inputs the deserialized data to the fifth round of SHA256-1, and the hash computation circuit 2130 computes the subsequent rounds(Round 4 to Round 63). In addition, the second deserializer 2120 receives the serialized data including the result of SHA 256-0 as the hash intermediate states, and deserializes the serialized data to 8 32-bit hash intermediate states. The adder 2140 adds the deserialized data to the result of the final round (i.e., Round 63) of SHA256-1, and outputs the added result as the result of the first stage 2100. The result of the first stage 2100 is output to the second stage 2200.

Wherein, each cluster 2000 is divided into a first stage 2100 and a second stage 2200. The first stage 2100 is configured either to perform the entire SHA256-1 hash computation or to perform the computations for the other rounds (rounds 4~63) excluding the rounds (round 0 to round 3) for the first four messages of the SHA256-1 hash computation. Note that the round (circuit) includes expansion (expander) and compression (compressor), and round function is a circuit or computation performing round function within the compression (compressor).

Additionally, the first stage 2100 is configured to add the result of the final round function of SHA256-1 to the hash intermediate states which are the result of SHA256-0 performed at the cluster_top 1000 and output the added result as the final result.

In this process, the first stage 2100 is configured to receive serialized data corresponding to 8 32-bit hash intermediate states output from the cluster_top 1000, deserialize the received serialized data, then input the deserialized data into the rounds 2130, and, in addition, add the hash intermediate states for the final round (round 63) of the first stage 2100 to the hash intermediate states output from the SHA256-0 hash computation of the cluster_top 1000, then deliver the added result to the second stage 2200.

The second stage 2200 is configured to receive the hash intermediate states from the first stage 2100 and input to the first round among the 64 rounds, add the finally computed hash intermediate states to the initialization vector through a second adder 2240, and output the added result. Thus, the role of the corresponding cluster is fulfilled. The second stage 2200 does not require a deserialization process, performs 64 hash computations through a second hash computation circuit 2230, and outputs the result by adding the initialization vector to the hash computation result through the second adder 2240.

Meanwhile, in stage 2, after executing 60 rounds of the hash function from Round 1 to Round 60, it is possible to determine in advance whether a valid block has been found by monitoring the value of e for the previous three rounds of h. In SHA256-2, the output hash value is arranged in the order of h, g, f, e, d, c, b, and a, forming a 256-bit sequence. If the value of h in the final hash values does not satisfy the Bitcoin target value difficulty condition of being at least zero, it is determined that no valid hash block has been found, and it is configured to exit without executing Round 61 to 63. If the value of e for the previous three rounds of h is zero, the remaining three rounds (Round 61 to 63) are executed, and if the resulting hash value is less than or equal to the target value, a new valid hash block is considered to have been found.

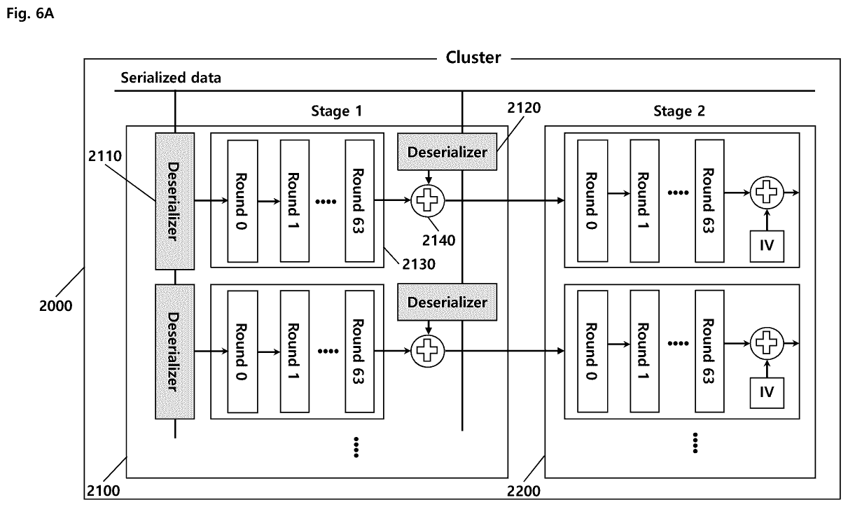

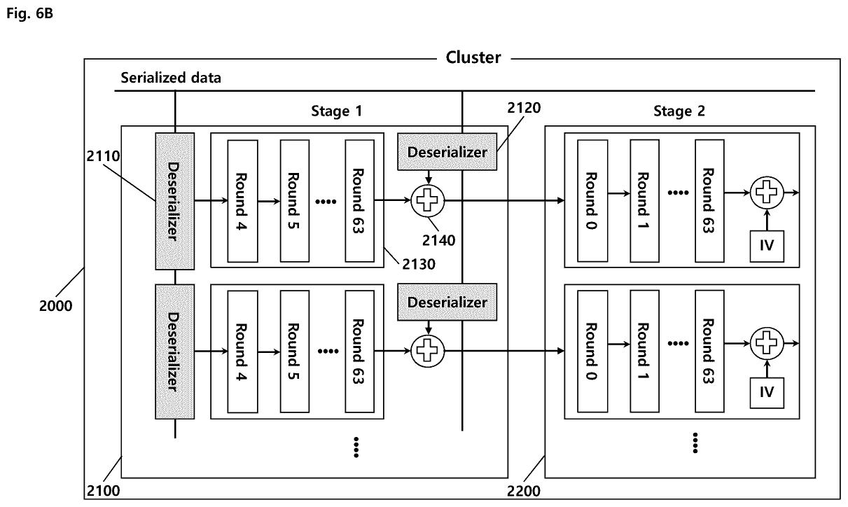

FIG. 6A is a diagram illustrating the concept of multi-deserializing for the case that entire multiple rounds are provided in a stage of a cluster adopting the multi-deserializing method for hash computation according to embodiments of the present disclosure.

As shown in FIG. 6A, the multi-deserializing method for hash computation according to an embodiment of the present disclosure is configured such that each of the multiple stages 2100, 2200 within each cluster 2000 provides multiple rounds 2130, so that a plurality of rounds each including expansion and compression are performed independently for multiple versions.

The first stage 2100 is configured to receive multiple hash intermediate states obtained by performing the SHA256-0 hash computations for multiple different versions respectively as serialized data, deserialize the serialized data, and then input the deserialized data to respective round to perform respective expansion and compression (rounds 0 to 63).

Since the SHA256-0 hash computation results differ for each of the multiple versions, each of the multiple hash intermediate states inputted to the rounds (rounds 0 to 63) for each of the multiple versions should be independently deserialized respectively.

The serialized data received from the cluster_top 1000 is deserialized in the first stage 2100, where the SHA256-1 hash computation for the first version is firstly performed.

The serialized data on the data line is first deserialized for computing rounds for the first version, and then the serialized data on the data line is deserialized again for computing rounds for the next version. The process that the serialized data is deserialized and inputted to the corresponding rounds is continuously repeated as many as the number of versions capable of simultaneous computations in the hash computing chip according to the present disclosure.

Meanwhile, the final hash computation result of SHA256-1 is generated and outputted by adding the hash computation result of SHA256-0 performed at the cluster_top 1000 to the result of the last round (round 63) of the hash computation circuit 2130 in the first stage 2100. In this process, the hash computation result of SHA256-0 is received as serialized data to be deserialized again via a second deserializer 2120 so as to be added to the result of the last round of the first stage 2100.

The second deserializer 2120 is configured, like the first deserializer 2110, to perform deserialization for the number of versions,

FIG. 6B is a diagram illustrating the concept of multi-deserializing for the case that a part of multiple rounds are provided in a stage of a cluster adopting the multi-deserializing method for hash computation according to embodiments of the present disclosure.

As shown in FIG. 6B, the multi-deserializing method for hash computation according to an embodiment of the present disclosure is configured such that the first four rounds (i.e., rounds 0 to 3) of SHA256-1 along with SHA256-0 are performed at the cluster_top 1000, and then the result is converted into serialized data for transmission.

In this case, the first stage 2100 restores the serialized data to 8 32-bit hash intermediate states through the first deserializer which deserializes the serialized data, and then performs the SHA 256-1 computation starting from round 4 (the 5th round).

In addition, the first stage 2100 is configured to add the computation result of the round 63 (64th round) of SHA256-1 and the result deserialized, by the second deserializer 2200, from the serialized data which is received from the cluster_top 1000 and generated from the hash intermediate states obtained by performing the SHA256-0 hash computation. Thus the first stage 21100 outputs the added result to the second stage 2200.

The second stage 2200 is configured to perform computations from round 0 to round 63, and add the results of the round 63 to the initialization vector through the second adder 2240 to output the final hash result, thereby completing the hash computation for a specific nonce.

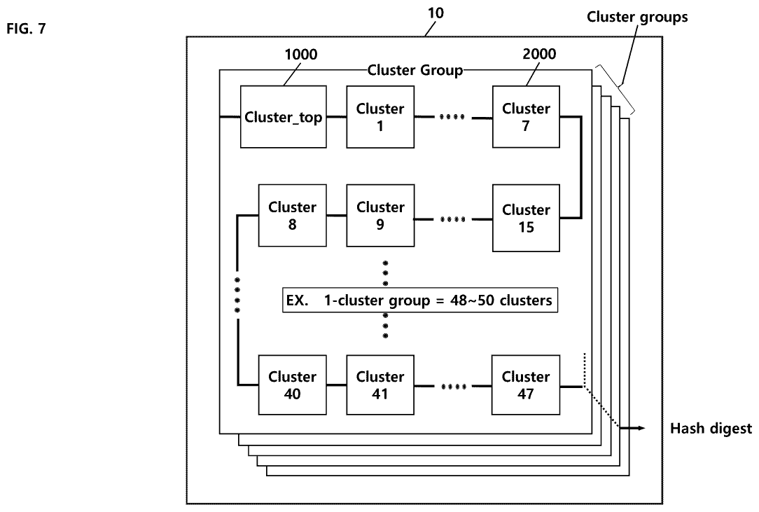

FIG. 7 is a structure illustrating a hash computing chip adopting the multi-deserializing method for hash computation according to an embodiment of the present disclosure.

As shown in FIG. 7, the hash computing chip according to an embodiment of the present disclosure is configured to include a cluster_top 1000 and multiple clusters 2000.

The cluster_top 1000 is configured to perform a plurality of hash computations corresponding to the number of versions to be executed simultaneously, and the hash computations include either the SHA256-0 hash computations, or the hash computations up to the 4th round of SHA 256-1 hash computations as well as SHA256-0 hash computations. Each cluster 2000 is configured to perform SHA256-1/2 hash computations or to perform hash computations from the 5th round of SHA256-1 to SHA256-2 corresponding to the number of versions to be executed simultaneously.

Thus, the hash computing chip may be composed of a cluster_top 1000 and approximately 250 clusters 2000. Of course, the exact number of clusters 2000 is determined according to the available area of the chip. In other words, if the number of clusters is small, the chip should be operated to perform more iterative computations.

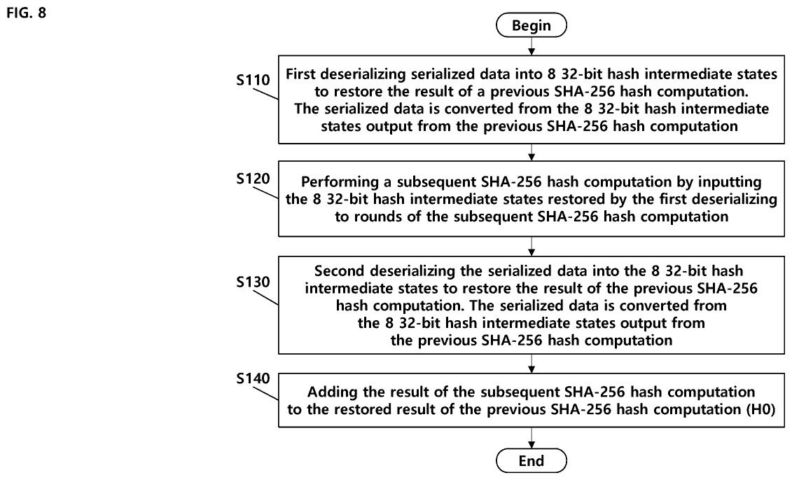

FIG. 8 is a flowchart showing a hash computing process adopting the multi-deserializing method for hash computation according to an embodiment of the present disclosure.

As shown in FIG. 8, the multi-deserializing method for hash computation according to an embodiment of the present disclosure comprises, through a first deserializer 2100, first deserializing serialized data into 8 32-bit hash intermediate states to restore the result of a previous SHA-256 hash computation (S110). Wherein the serialized data is converted from the 8 32-bit hash intermediate states output from the previous SHA-256 hash computation and transmitted by a serializer 1100 in the cluster_top 1000.

Next, the multi-deserializing method comprises performing a subsequent SHA-256 hash computation through the hash computation circuit 2130, by inputting the 8 32-bit hash intermediate states restored by the first deserializing to rounds of the subsequent SHA-256 hash computation (S120). Wherein the serialized data is multi-deserialized and the multi-deserialized data are used for inputs of the rounds for a plurality of SHA-256 hash computations, and thereby alleviating routing complexity by reducing bit width of data required to transmit the hash intermediate states.

Wherein, S110 to S120 involve receiving serialized data representing the result of the SHA256-0 hash computation, deserializing the serialized data, and inputting the deserialized data to rounds of the subsequent SHA256-1 hash computation.

Subsequently, the multi-deserializing method further comprises, through a second deserializer 2120, second deserializing the serialized data into the 8 32-bit hash intermediate states to restore the result of the previous SHA-256 hash computation (S130). Wherein the serialized data is converted from the 8 32-bit hash intermediate states output from the previous SHA-256 hash computation, and transmitted by a serializer 1100 in the cluster_top 1000. The second serializer 2120 receives the serialized data being synchronized with the execution timing of the SHA256-1 hash computation.

Subsequently, the multi-deserializing method further comprises adding a hash computation result, through an adder 2140, by adding the result of the subsequent SHA256 hash computation to the restored result (H0) of the previous SHA256 hash computation (S140). Thus the hash computation in the first stage 2100 is complete and the hash computation result (i.e., the added result) is transferred to the second stage 2200.

As described above, the hash computing chip according to the present disclosure is configured to perform hash computations repeatedly with a plurality of clusters including a plurality of stages configured to perform a plurality of SHA-256 hash computations, thereby it is effective to increase the hash rate by improving chip performance.

In addition, the hash computing chip according to the present disclosure is configured to serialize 8 32-bit hash intermediate states, which are the result of a previous SHA-256 hash computation circuit, transmit the serialized data to a subsequent SHA-256 hash computation circuit, and then deserialize the serialized data for use in each round of the subsequent SHA-256 hash computation circuits, thereby it is effective to reduce hardware area and power consumption and improve performance by alleviating routing complexity.

Furthermore, the hash computing chip according to the present disclosure is configured to alleviate the routing complexity caused by the 256-bit data width to 1-bit data width, when inputting the hash intermediate states output from the previous SHA-256 hash computation circuit to the subsequent SHA-256 hash computation circuit in each cluster, thereby it is effective to reduce hardware area and power consumption, improve the performance, reliability and yield of the hash computing chip.

At least one of the components, elements, modules or units (collectively “components” in this paragraph) represented by a block or an equivalent indication in the drawings including the cluster-top 1000 and each of the clusters 2000 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto

The present disclosure is described above with reference to the embodiments illustrated in the drawings; however, these are merely examples, and those skilled in the art will understand that various modifications and equivalent alternative embodiments are possible. Therefore, the technical scope of the present disclosure should be determined by the appended claims.

What is claimed is:

1. A method of hash computation through multi-deserialization, the method comprising:
by a first deserializer, first deserializing serialized data into 8 32-bit hash intermediate states to restore the result of a previous SHA-256 hash computation, wherein the serialized data is converted from 8 32-bit hash intermediate states output from the previous SHA-256 hash computation; and
by a subsequent SHA-256 hash computation circuit, performing a subsequent SHA-256 hash computation by inputting the 8 32-bit hash intermediate states restored by the first deserializing to rounds of the subsequent SHA-256 hash computation,
wherein the serialized data is multi-deserialized and the multi-deserialized data are used for inputs of the rounds for a plurality of SHA-256 hash computations, and thereby alleviating routing complexity by reducing bit width of data required to transmit the hash intermediate states.

2. The method of claim 1, wherein the method further comprising:
by a second deserializer, second deserializing the serialized data into the 8 32-bit hash intermediate states to restore the result of the previous SHA-256 hash computation, wherein the serialized data is converted from the 8 32-bit hash intermediate states output from the previous SHA-256 hash computation; and
by a first adder, adding the result of the subsequent SHA-256 hash computation to the restored result of the previous SHA-256 hash computation.

3. The method of claim 1, wherein the hash intermediate states are one of a computation result obtained by 64th round of 0th SHA-256 hash computation, or a computation result obtained by pre-computations of 0th to 3rd round of 1st SHA-256 hash computation in addition to the 64th round of the 0th SHA-256 hash computation, in a structure consecutively performing a plurality of SHA-256 hash computations.

4. The method of claim 3, wherein the performing of the subsequent SHA-256 hash computation includes: performing one of the computations of 64 rounds of the 1st SHA-256 hash computation, or the computations from 5th round to 64th round of the 1st SHA-256 hash computation, in the structure consecutively performing the plurality of SHA-256 hash computations.

5. The method of claim 2, wherein the method further comprising: sharing a serial bus for transmitting the serialized data to consecutively perform the plurality of SHA-256 hash computations, by unrolling over a plurality of different versions and rolling for 32-bit nonce.

6. A hash computing chip comprising:
a cluster_top; and
a plurality of clusters,
wherein the cluster_top is configured to convert hash intermediate states of a SHA-256 hash computation into serialized data and provide the serialized data to the plurality of clusters,
wherein the plurality of clusters are configured to deserialize the serialized data received from the cluster_top and perform remaining SHA-256 hash computations subsequently to the SHA-256 hash computation of the cluster_top, and
wherein the serialized data is multi-deserialized and the multi-deserialized data are used for inputs of the rounds for a plurality of SHA-256 hash computations, and thereby alleviating routing complexity by reducing bit width of data required to transmit the hash intermediate states.

7. The hash computing chip of claim 6, wherein each of the plurality of clusters includes:
a first stage; and
a second stage,
wherein the first stage includes:
a predetermined number of first deserializers;
a predetermined number of hash computation circuits;
a predetermined number of second deserializers; and
a predetermined number of adders, and
wherein the second stage is configured to receive each of the computation results of the first stage as an input message, perform message expansion for the input message, perform computations for a plurality of round functions, and output a predetermined number of hash computation results each by adding an initial vector to corresponding final result of the plurality of round functions.

8. The hash computing chip of claim 6, wherein the hash computing chip is further configured to share a serial bus for transmitting the serialized data to consecutively perform the plurality of SHA-256 hash computations, by unrolling over a plurality of different versions and rolling for 32-bit nonce.

9. The hash computing chip of claim 6, wherein each of the plurality of clusters comprises:
a first deserializer configured to receive serialized data converted from 8 32-bit hash intermediate states output from a previous SHA-256 hash computation circuit, and deserialize the received serialized data back into the 8 32-bit hash intermediate states to restore the result of the previous SHA-256 hash computation; and
a subsequent SHA-256 hash computation circuit configured to input the 8 32-bit hash intermediate states restored by the first deserializer to round circuits of the subsequent SHA-256 hash computation circuit and perform the subsequent SHA-256 hash computation.

10. The hash computing chip of claim 6, wherein each of the plurality of clusters comprises:
a second deserializer configured to receive serialized data converted from 8 32-bit hash intermediate states output from a previous SHA-256 hash computation circuit, and deserialize the received serialized data back into the 8 32-bit hash intermediate states to restore the result of the previous SHA-256 hash computation; and
a first adder configured to add the result of the subsequent SHA-256 hash computation to the restored result of the previous SHA-256 hash computation.

11. The hash computing chip of claim 6, wherein the hash intermediate states are one of a computation result obtained by 64th round circuit of 0th SHA-256 hash computation circuit, or a computation result obtained by pre-computations of 0th to 3rd round circuit of 1st SHA-256 hash computation circuit in addition to the 64th round of the 0th SHA-256 hash computation circuit, in a structure consecutively performing a plurality of SHA-256 hash computations.

12. The hash computing chip of claim 6, wherein the subsequent SHA-256 hash computation circuit includes: one of computation circuits configured to perform 64 rounds of the 1st SHA-256 hash computation, or computation circuits configured to perform 5th round to 64th round of the 1st SHA-256 hash computation, in the structure consecutively performing the plurality of SHA-256 hash computations.
